(19) United States
(12) Patent Application Publication
(10) Pub. No.: US 2014/0183276 A1
(43) Pub. Date: Jul. 3, 2014

(54) APPARATUS FOR DETERMINING TANK LEVEL ON A SLOPE

(71) Applicant: AGCO Corporation, Duluth, GA (US)

(72) Inventor: Glen D. Kroese, Jackson, MN (US)

(73) Assignee: AGCO Corporation, Duluth, GA (US)

(21) Appl. No.: 14/140,744

(22) Filed: Dec. 26, 2013

Related U.S. Application Data
(60) Provisional application No. 61/747,881, filed on Dec. 31, 2012.

(51) Int. Cl. A01C 23/00; A01M 7/00

(52) U.S. Cl. CPC A01C 23/008; A01M 7/0085
USPC 239/74

(57) ABSTRACT

A crop sprayer used to deliver chemicals to agricultural crops in a field includes a chassis, a chemical storage tank mounted on chassis used to store fluid to be sprayed on the field, and apparatus for gauging an amount of fluid in the tank. The tank has two planes of symmetry perpendicular to one another forming a central axis created by the intersection of the planes of symmetry The apparatus includes a sight gauge, an inclinometer, and a multiplier scale. The inclinometer is mounted to the tank on a plane created by the sight gauge and the central axis of the tank created by the intersection of the planes of symmetry.

### CROSS REFERENCE TO RELATED APPLICATION

This application claims the benefit of U.S. Provisional Application No. 61/747,881 entitled APPARATUS FOR DETERMINING TANK LEVEL ON A SLOPE, filed Dec. 31, 2012, which is hereby incorporated by reference in its entirety.

### BACKGROUND OF THE INVENTION

1. Field of Invention

This invention relates to onboard tanks for agricultural sprayers, and more particularly to a measurement apparatus for the level of a liquid contained in a tank carried on an agricultural sprayer.

2. Description of Related Art

The high crop yields of modern agribusiness require application of fertilizers, pesticides, and herbicides. Dispersing these chemicals onto high acreage fields requires specialized machines mounted on or towed by a vehicle. An example of such a machine is the self-propelled crop sprayer.

A common design for a self-propelled crop sprayer includes a dedicated chassis with a tank to hold the chemical and boom arms extending outward from the chassis. Supply lines run along the boom arms to a plurality of nozzles spaced apart along the length of the boom arms configured to disperse the chemicals. In operation, as the crop sprayer crosses the field, fluid is pumped from the tank through the supply lines along the boom arms, and out through the nozzles. This allows the self-propelled sprayer to distribute the fluid along a relatively wide path.

The crop sprayer operator periodically needs to monitor the level of the fluid in the tank. Devices for measuring the amount of chemical remaining in the tank are known in the industry and typically include a transparent sight gauge connected near the top and bottom of the tank. However, a frequent problem facing such devices is that the tank is subject to tilt, such as when the crop sprayer is stopped on uneven terrain. When the tank is not level, the sight gauge can give an erroneous reading. Sometimes, multiple sight gauges at opposite points in the tank are used and the levels of the multiple gauges are averaged to obtain a more accurate reading.

Based on the foregoing, it would be desirable to provide a tank level monitoring apparatus that increases reliability and accuracy of the tank level readings.

### OVERVIEW OF THE INVENTION

In one embodiment, the invention is directed to a crop sprayer used to deliver chemicals to agricultural crops in a field. The crop sprayer includes a chassis, a chemical storage tank mounted on chassis used to store fluid to be sprayed on the field, and apparatus for gauging an amount of fluid in the tank. The tank has two planes of symmetry perpendicular to one another forming a central axis created by the intersection of the planes of symmetry The apparatus includes a sight gauge, an inclinometer, and a multiplier scale. The inclinometer is mounted to the tank on a plane created by the sight gauge and the central axis of the tank created by the intersection of the planes of symmetry.

These and other features and advantages of this invention are described in, or are apparent from, the following detailed description of various example embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a view of a crop sprayer; and

FIG. 2 is a view of apparatus for measuring the level in a tank of the crop sprayer of FIG. 1 according to an embodiment of the invention.

Corresponding reference characters indicate corresponding parts throughout the views of the drawings.

### DESCRIPTION OF EXAMPLE EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

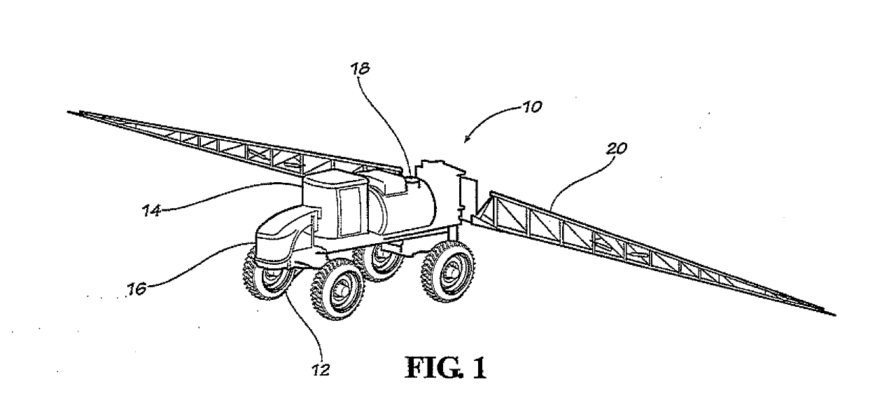

FIG. 1 shows a crop sprayer 10 used to deliver chemicals to agricultural crops in a field. Crop sprayer 10 includes a chassis 12 and a cab 14 mounted on the chassis 12. Cab 14 may houses an operator and a number of controls for the crop sprayer 10. An engine 16 may be mounted on a forward portion of chassis 12 in front of cab 14 or may be mounted on a rearward portion of the chassis 12 behind the cab 14. The engine 16 may be commercially available from a variety of sources and may comprise, for example, a diesel engine or a gasoline powered internal combustion engine. The engine 16 provides energy to propel crop sprayer 10 and also may provide energy used to spray fluids from the crop sprayer 10.

The crop sprayer 10 further includes at least one storage tank 18 used to store fluid to be sprayed on the field. The fluid may include chemicals, such as but not limited to, herbicides, pesticides, and/or fertilizers. The at least one storage tank 18 may be mounted on chassis 12, either in front of or behind cab 14. Crop sprayer 10 may include more than one storage tank 18 to store different chemicals to be sprayed on the field. The stored chemicals may be dispersed by crop sprayer 10 one at a time or different chemicals may be mixed and dispersed together in a variety of mixtures.

Boom arms 20 extending from each side of the crop sprayer 10 are used to distribute the fluid from the at least one tank 18 over a wide swath as the crop sprayer 10 is driven through the field. The boom arms 20 extending from either side of the crop sprayer 10 are desirably substantially identical but mirror images of each other. The fluid is conveyed by a fluid supply system 22 using pipes and/or hoses, broadly conduits, 24 to various spray nozzles (not shown) spaced along the boom arms 20. As is known in the art, the fluid supply system 22 includes at least one pump (not shown) configured to pumps fluid from the at least one tank 18 through the various hoses and/or pipes 24 to the spray nozzles (not shown). An operator of the crop sprayer 10 may use controls (not shown) located in the cab 14 to control movement of the boom arm 20 and to turn on and to shut off the fluid flow to the plurality of spray nozzles.

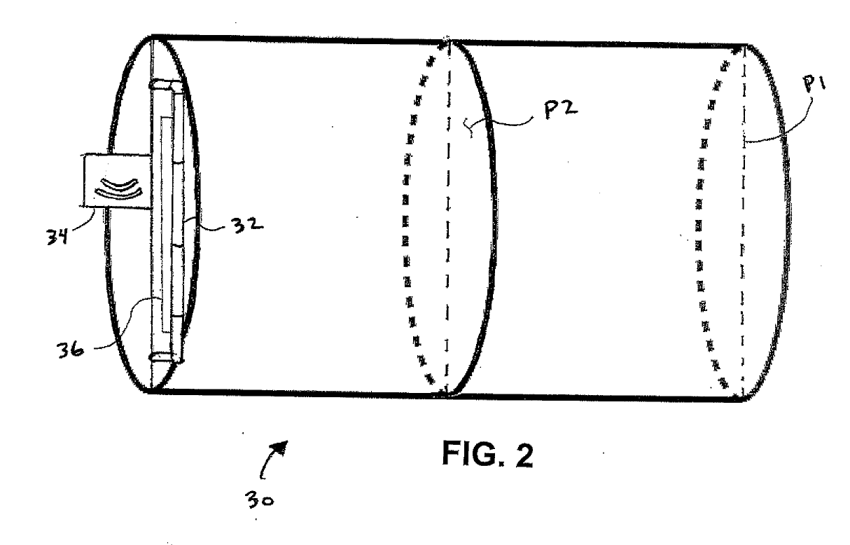

FIG. 2 schematically shows an apparatus generally designated 30 for gauging an amount of liquid remaining in the tank 18. The apparatus comprises a sight gauge 32, an inclinometer 34, and a multiplier scale 36. The apparatus 10 is capable of differentiating between a level condition wherein the tank 18 is substantially parallel to a reference plane such as a horizontal plane, and an unlevel condition wherein the tank 18 is momentarily askew to the reference plane. Ordinarily, the tank 18 and the fluid therein are temporarily titled at an angle to the reference plane when the sprayer itself is tilted. This commonly occurs, for example, when the sprayer is positioned on an incline.

In one embodiment, the sight gauge 32 includes a bracket to hold a clear tube that is connected to the top and bottom of the tank 18. In one embodiment, the bracket has graduations on it to allow for measurement of the level of the liquid in the tube. The graduations could also be applied to the tube for purposes of this invention. Desirably, the tube makes a loop into the tank 18 so that air-lock does not prevent accurate reading, as would be understood by one skilled in the art. The illustrated embodiment uses the top and bottom of the tank 18.

The tank 18 has at least two planes of symmetry P1 and P2. These two planes need to be perpendicular to each other. Desirably, the sides of the tank 18 are rigid allowing the planes of symmetry to maintain their relative position to the tank 18.

The liquid level of the tank 18 is measured through the use of the single sight gauge 32. Next a multiplier is read off of the inclinometer 34 with the adjacent multiplier scale 36. The inclinometer 34 is assembled to the tank 18 on a plane that is created by the sight gauge 32 and the central axis of the tank 18 created by the intersection of the planes of symmetry. The measurement taken from the sight gauge 32 is then multiplied by the inclinometer multiplier from the multiplier scale 36 to achieve the actual volume of the liquid in the tank 18.

The inclinometer 34 may be of any standard inclinometer design, such as a “valley” design that would use a bubble suspended in a liquid to measure the incline, however other designs such as a pendulum version of an inclinometer could be used to determine the multiplier. In another embodiment, a plumb bob could take a two-dimensional reading of the slope. This would eliminate the need for keeping the inclinometer in plane with the sight gauge 32 and symmetry axis as previously discussed. A commercially available multi-directional inclinometer known as a Dual Axis Clinometer, marketed by Schaevitz Sensing Systems, Inc. of Phoenix, Ariz., can be used for this purpose.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. A crop sprayer used to deliver chemicals to agricultural crops in a field, the crop sprayer comprising:
a chassis;
a chemical storage tank mounted on chassis used to store fluid to be sprayed on the field, wherein the tank has two planes of symmetry perpendicular to one another forming a central axis created by the intersection of the planes of symmetry;
apparatus for gauging an amount of fluid in the tank, the apparatus comprising:
a sight gauge;
an inclinometer; and
a multiplier scale;
wherein the inclinometer is mounted to the tank on a plane created by the sight gauge and the central axis of the tank created by the intersection of the planes of symmetry.

2. The crop sprayer of claim 1 wherein the sight gauge is a clear tube connected to the top and bottom of the tank and is marked with graduations to allow for measurement of the level of liquid in the tube.

3. The crop sprayer of claim 1 wherein the sides of the tank are rigid allowing the planes of symmetry to maintain their relative position in the tank.

4. The crop sprayer of claim 1 wherein the inclinometer is marked with a multiplier scale.
